(19) United States
(12) Patent Application Publication
(10) Pub. No.: US 2025/0034352 A1
(43) Pub. Date: Jan. 30, 2025

(54) ZEOLITE/ELASTOMER COMPOSITE MATERIAL

(71) Applicant: Arkema France, Colombes (FR)

(72) Inventors: Guillaume ORTIZ, Lacq (FR); Cécile LUTZ, Lacq (FR); Karine LOPEZ, Lacq (FR)

(73) Assignee: Arkema France, Colombes (FR)

(21) Appl. No.: 18/714,166

(22) PCT Filed: Nov. 28, 2022
(86) PCT No.: PCT/EP2022/083447

§ 371 Date: May 29, 2024

(30) Foreign Application Priority Data
Nov. 30, 2021 (FR) FR2112718

(51) Int. Cl. C08K 3/34

(52) U.S. Cl. CPC C08K 3/34; C08K 2201/003

(57) ABSTRACT

The present invention relates to a composite material comprising a) at least one elastomer, and b) an amount equal to or greater than 30% by weight, relative to the total weight of said composite material, of type 3A zeolite in which the cationic sites are occupied by the potassium cation, the sodium cation, at least one alkaline earth metal cation from column IIA of the periodic table and the hydronium ion.

The invention also relates to the use of said composite material as an adsorbent material, for the production of master batches, for packaging and for the production of double-glazing.

The present invention relates to the field of composite materials and especially to elastomeric materials in which are incorporated zeolite crystals, especially 3A zeolite crystals, said materials being useful in diverse applications in which the adsorption of water is desired, more particularly in drying applications.

The present invention thus relates to the composite materials obtained through incorporation of crystals of zeolite, particularly 3A zeolite, in an elastomer matrix, more specifically a thermoplastic elastomer matrix.

The zeolite crystals are typically incorporated using high-powered mixers, for example Brabender-type mixers, laminar mixers, twin-screw mixers, extruders, but also calenders, etc. However, the high viscosity that develops during mixing the zeolite crystals with the polymer matrix often makes incorporation difficult. This results inter alia in the need to restrict the level of incorporation of the zeolite crystals, whereas what is however desired is to achieve the maximum incorporation of the zeolite crystals in the polymer matrix in order to best ensure the desired adsorption properties, for example desiccant properties.

Moreover, and for reasons of effectiveness of the elastomer/zeolite composite material in certain applications, it can sometimes be necessary to restrict adsorption to specific molecules, such as water in drying applications, while as far as possible avoiding potential co-adsorption of very small molecules, for example nitrogen, oxygen and argon. This is because such molecules could alter the mechanical properties, visual perception or tactile perception of the composite material as a consequence of their possible untimely desorption during the production or use of said composite material.

Various studies have already proposed solutions that make it possible to incorporate zeolite crystals in polymer matrices; these include for example those described in document EP2690136 A1, in which a thermoplastic elastomer composition comprises a zeolite, a thermoplastic polymer and an elastomer partially cured with a phenolic resin. The zeolite introduced into the phenolic resin before curing makes it possible to eliminate the yellow coloration commonly resulting from the activation of crosslinking to the phenolic resin by stannous chloride. The zeolite content in the final composition may be as high as 47%, but much lower contents are preferable.

Application WO2011150237 A1 describes an article moulded from two silicone fluid precursors into which a sorbent material had been introduced beforehand. The mixture is sufficiently fluid for it to be injected. The viscosity is then increased by crosslinking the mixture such that the article solidifies. The final mixture consists of crosslinked silicone (45% to 95%) and a sorbent material (5% to 55%) that may especially be calcium oxide or a zeolite, which gives the article protective properties against moisture, for example in the explosive charge of an airbag. There is no particular selection of the nature of the sorbent material; only zeolite 13X is mentioned in the examples. This type of zeolite does however have significant porosity, which can be harmful in certain applications, particularly on account of possible desorption of gaseous molecules.

Document EP1323468 discloses an adsorbent material comprising 45% to 80% by weight of a porous functional solid, for example a zeolite, incorporated in a polymer matrix that comprises a thermoplastic polymer having a second porosity in addition to the first porosity of the porous functional solid. This document does not deal with composite material comprising elastomeric polymer.

Also known, from document FR2819247, is a method for preparing a zeolite A that can be used in two-component polyurethane resin formulations, said zeolite A having a degree of exchange of sodium, potassium, calcium or magnesium and hydronium ions of respectively 10% to 69%, 28% to 55%, 2% to 45% and 1% to 20%. The zeolite is introduced in small proportion into the 2K PU mixtures.

The earlier studies highlight the need to have access to composite materials incorporating a significant zeolite content, but also the difficulty inherent in producing such composite materials, as a consequence particularly of the often excessively high viscosity during mixing of the components.

There consequently remains a need to reduce the difficulty of incorporating zeolite in high proportion into a polymer matrix, and into an elastomer in particular, particularly a need to reduce the viscosity during preparation of the polymer matrix/zeolite mixture. It would therefore be advantageous to have access to composite materials comprising adsorbent materials, to easier production thereof, and thus to composite materials that are adsorbent and simple to prepare, and especially to effective and readily available desiccant composite materials.

It has now been found that the present invention makes it possible to achieve the above objectives in full or at least in part, through the incorporation of a specific zeolite in an elastomeric polymer matrix. Further objects will become more apparent in the account of the present invention that follows.

Thus, and according to a first subject-matter, the present invention relates to a composite material comprising:
a) at least one elastomer, and
b) an amount equal to or greater than 30% by weight, relative to the total weight of said composite material, of type 3A zeolite in which the cationic sites are occupied by the potassium cation, the sodium cation, at least one alkaline earth metal cation from column IIA of the periodic table and the hydronium ion.

The zeolite employed in the composite material of the present invention is, as indicated earlier, a type 3A zeolite. The 3A zeolite has a Si/Al atomic ratio of between 0.90 and 1.10, preferably between 0.95 and 1.05.

This 3A zeolite has sites, termed “cationic sites”, these sites being as it were occupied by cations intended to ensure the electrical neutrality of said 3A zeolite. The cationic sites are occupied by the potassium cation to an extent generally and preferably of from 35% to 70% inclusive, the sodium cation to an extent generally and preferably of from 2% to 62% inclusive, at least one alkaline earth metal cation selected from magnesium, calcium, strontium and barium to an extent generally and preferably of from 2% to 30% inclusive, and the hydronium cation to an extent generally and preferably of from 1% to 5% inclusive, percentages being expressed in moles of cation relative to the total number of moles of exchangeable sites, as indicated below. It should be understood that the sum of the percentages of each of the cations listed above comes to 100% in order to ensure the electrical neutrality of the zeolite, as has just been stated.

It was a complete surprise to discover that the crystals of specifically this 3A zeolite can be readily incorporated in high proportion, for example greater than or equal to 30% by weight, relative to the total weight of the composite material, into an elastomer matrix, and into a thermoplastic elastomer matrix in particular.

The present invention accordingly proposes a composite material comprising crystals of 3A zeolite. This 3A zeolite is advantageously and most often an adsorbent zeolite, that is to say it has been activated, as explained further on in the description. The incorporation of this 3A zeolite has been improved in order to facilitate its incorporation in high proportion into a polymer matrix and/or, for the same productivity (this parameter depending essentially on the viscosity of the mixture when molten), to increase the proportion of zeolite incorporated into an elastomer matrix, preferably into a thermoplastic elastomer matrix, and more particularly into a natural rubber (NR), a synthetic rubber, halogenated polymers and copolymers, polysulfonated rubbers, polysiloxanes and also mixtures of two or more thereof, in any proportions.

The 3A zeolite defined above and intended for use in the composite material of the invention facilitates mixing with the elastomer matrix, as a consequence in particular of permitting a reduction in viscosity or through the incorporation of a larger amount of zeolite in said elastomer matrix. This is directly reflected not just in a reduction in the preparation time of the composite material, and therefore in improved productivity, but also in a possibility of increasing the proportion of zeolite in the composite material and consequently of further improving the adsorption properties for the same mass of mixture.

It was also observed that, on account of the 3A zeolite present in the composite material of the invention, the latter has little or no capacity for the adsorption of argon, nitrogen, oxygen or noble gases.

Specifically, the 3A zeolite as defined previously confers desiccant properties on the composite material of the invention through its properties of adsorbing molecules of water without co-adsorption, or with adsorption only in very small amounts, of small molecules potentially present in the atmosphere that could be in contact with the composite material, for example nitrogen, but also oxygen or argon. Without wishing to be bound by any particular theory, this absence or virtual absence of co-adsorption is due mainly to a relatively high degree of exchange of potassium cation (K⁺), typically greater than or equal to 35%, as indicated further on in the description.

Accordingly, and in a preferred embodiment, the composite material of the present invention comprises a 3A zeolite in which the cationic sites are occupied:
by the potassium cation in an amount of between 35% and 70% inclusive, preferably between 38% and 68% inclusive, more preferably between 40% and 65% inclusive, and advantageously between 45% and 60% inclusive,
by an alkaline earth metal cation in an amount of between 2% and 30% inclusive, preferably between 3% and 25% inclusive, more preferably between 5% and 20% inclusive,
by the sodium cation in an amount of between 2% and 62% inclusive, and
by the hydronium cation in an amount of between 1% and 5% inclusive.

As previously indicated, the alkaline earth metal cation is selected from the magnesium cation, the calcium cation, the strontium cation and the barium cation. According to a very particularly preferred aspect of the present invention, the alkaline earth metal cation is selected from the calcium cation (Ca²⁺) and the magnesium cation (Mg²⁺) and also mixtures thereof in any proportions.

In one embodiment of the invention where the selected alkaline earth metal cation is calcium, preference is given to a degree of calcium exchange, that is to say where the cationic sites are occupied by the calcium cation, within a range of between 5% and 30% inclusive, preferably of between 5% and 20% inclusive, more preferably between 5% and 15% inclusive.

According to another embodiment where the selected alkaline earth metal cation is magnesium, preference is given to a degree of magnesium exchange of between 2% and 15%, preferably between 4% and 10%.

It should be understood that all the exchangeable sites in the 3A zeolite are occupied by the cations previously indicated, the sum of the percentages being equal to 100%, as previously indicated.

According to a preferred embodiment of the present invention, the composite material comprises 3A zeolite crystals in which the number-average diameter, calculated by counting in SEM images as indicated further below, is between 0.1 μm and 4.0 μm inclusive, preferably between 0.2 μm and 3.5 μm inclusive, more preferably between 0.3 μm and 3.0 μm inclusive.

Crystals having a number-average diameter below or above the limits indicated above can however be used in the context of the present invention. A number-average diameter between the limits indicated above has however been observed to favour incorporation into the elastomer matrix, both in terms of incorporation time and the amount of zeolite incorporated.

As indicated previously, the zeolite content in the elastomer matrix of the composite material of the present invention is greater than or equal to 30% by weight relative to the total weight of the composite material. Preference is given to a composite material according to the present invention wherein the zeolite content is between 30% and 90% inclusive, preferably between 40% and 85% inclusive, better still between 45% and 80% inclusive, and more preferably still between 50% and 80% inclusive, relative to the total weight of said composite material.

The composite material of the present invention may also comprise in addition to the elastomer matrix and the 3A zeolite an amount, generally minor and advantageously less than or equal to 20%, preferably less than or equal to 10%, and better still less than or equal to 5%, by weight, relative to the total weight of the zeolite(s), of one or more other zeolites selected from other zeolites of the LTA type, such as 4A zeolites and 5A zeolites, from faujasites (FAU of the LSX, MSX, X or Y type) having a Si/Al molar ratio of between 1 and 100, from type EMT zeolites, from type MFI zeolites having a Si/Al molar ratio of between 5 and 500, from type GIS zeolites (for example zeolite P), from type SOD zeolites (such as sodalite), from type MOR zeolites, from type HEU zeolites and from type BEA zeolites.

The zeolite present in the composite material of the present invention is well known to those skilled in the art and easily prepared starting from a type 3A, 4A or 5A zeolite by carrying out the desired cation exchanges, as indicated previously, or else from known procedures such as the one provided for example in document FR2819247, adapted to the degrees of exchange respectively referred to above.

A nonlimiting example of the preparation of the 3A zeolite that is useful in the context of the present invention comprises the following steps:
1/ bringing into contact the following aqueous solutions or suspensions:
   a-i an aqueous suspension of 3A (a-1), 4A (a-2) or 5A (a-3) zeolite,
   b-j an aqueous solution of alkaline earth metal salt(s) (b-1), or of potassium salt(s) (b-3) or of solutions of alkaline earth metal salt(s) and potassium salt(s) (b-2),
   c a solution of an acid,
according to one of the following methods:
   either simultaneously a-i, b-j and c,
   or a-i and b-j then c,
   or a-i and c then b-j,
   or b-j and c then a-i,
i and j being identical, it being understood that when i is equal to 1, then j may also be equal to 2, and when i is equal to 3, then j can also be equal to 2,
2/ then filtering and washing of the sold obtained,
3/ then drying and activating, preferably while flushing with a non-degrading gas, of the solid resulting from 2/.

When the solutions and the suspension are brought into contact simultaneously [(a-i) and (b-j) and (c)], mixing is generally carried out for a period of less than 1 hour at a temperature of generally between 15° C. and 80° C.

In the case where the suspension of the zeolite (a-i) and the acid solution (c) are mixed first, mixing is generally carried out for a few minutes, preferably with stirring, before being introduced into the aqueous salt solution (b-j), the reaction mixture then being stirred for a period of generally less than 1 hour at a temperature of generally between 15° C. and 80° C.

In the case where the solution of the salt(s) (b-j) and the acid solution (c) are mixed first, mixing is generally carried out for a few minutes, preferably with stirring, before introduction of the suspension of the zeolite (a-i), the reaction mixture then being stirred for a period of generally less than 1 hour at a temperature of generally between 15° C. and 80° C.

At the end of the synthesis steps described previously, solid crystals are obtained, in suspension in an aqueous solution. The crystals are filtered off and then washed with water. In the case where the suspension of the zeolite (a-i) and the solution of the salt(s) (b-j) are mixed first, mixing is generally carried out for a period of generally less than 1 hour, preferably with stirring, and at a temperature of generally between 15° C. and 80° C., affording crystals in the form of a suspension; said crystals being then washed with water before being introduced into the acid solution (c). Finally, the product is filtered off, then washed with a mixture of the acid solution and the wash water.

The concentrations and compositions of the solutions of the salts and of the acid are adjusted without particular difficulty such that the final zeolite corresponds to the formula indicated previously.

The proportions of the different cations present in the structure of the zeolites are measured in conventional manner by X-ray fluorescence, as indicated further below, the accuracy of the measurements being of the order of 1%. After having undergone exchange, the zeolite is then activated according to techniques well known to those skilled in the art, for example by subjecting the zeolite undergoing activation to a heat treatment generally comprising first a drying step, generally at between 60° C. and 110° C. for a period ranging usually from about half an hour to about 2 hours, followed by a step of activation at a temperature of generally between 300° C. and 600° C., preferably between 350° C. and 500° C. Preferably, the activation step is executed while flushing with a non-degrading gas (for example air, nitrogen, etc.), which permits the rapid removal of the water present in the zeolite and avoids hydrothermal degradation thereof while limiting adverse effects due to an activation temperature that is too high.

The zeolite used in the context of the present invention is a dewatered zeolite, that is to say desorbed of its water by heat treatment or having a very low residual water content. Typically, and according to a preferred embodiment of the present invention, the zeolite used for the preparation of the composite material according to the invention has a loss on ignition (LOI) of less than 3%, preferably less than 2%.

Degrees of exchange are determined by X-ray fluorescence analysis and the size of the zeolite crystals determined by counting in scanning electron microscopy images according to the characterization techniques described further on in the present description.

In addition, the composite material of the present invention may also comprise one or more additives well known to those skilled in the art, for example, and without limitation, one or more additives selected from crosslinkers, such as organic peroxides, colorants, pigments, antibacterial agents, antifog agents, swelling agents, dispersants, lubricants, flame retardants, fillers, especially ones that are inert to adsorption, binding agents and compatibilizers of the functional polyolefin type.

Accordingly, the composite material of the present invention comprises an elastomer matrix in which is incorporated a 3A zeolite. According to one embodiment, the elastomer matrix may be a thermoplastic elastomer matrix, and more specifically may be generally selected from natural rubbers, synthetic rubbers, halogenated polymers and copolymers, polysulfonated rubbers, polysiloxanes and also mixtures of two or more thereof, in any proportions.

The elastomer matrix comprises one or more elastomers selected from polysiloxanes (termed “silicones”), natural rubber (NR), polybutadienes (BR), polynitriles (NBR), hydrogenated or partially hydrogenated polynitriles (HNBR), styrene-isoprene-butadiene rubber (SIBR), polyisobutylenes and polyisobutenes (PIB), isobutylene-isoprene elastomer copolymers (IIR, termed “butyl rubbers”), which can be halogenated or non-halogenated, polychloroprenes (CR), EPDM (ethylene propylene diene monomer) rubbers, chlorinated polyethylenes (CM), polysulfonated rubbers (CSM), polyisoprenes (IR) and also mixtures of two or more thereof, in any proportions.

The elastomer matrix of the composite material of the present invention may optionally comprise polymers other than those listed above, for example, and without limitation, one or more polymers selected from polyethylenes, polypropylenes, ethylene-propylene rubbers (EPM), ethylene-butylene, hexylene or octylene copolymers, acrylic polymers (such as polyalkyl(meth)acrylates), polyvinyl chloride, ethylene-vinyl acetate copolymers, polyvinyl acetate, polyamides, polyesters, chlorinated polyethylenes, polyurethanes, polystyrenes, silicone polymers, styrene-ethylene-butylene-styrene (SEBS) block copolymers, epoxy resins and also mixtures of two or more thereof, in any proportions.

Preferably, the elastomer matrix of the composite material of the present invention is selected from polysiloxanes and synthetic rubbers, more preferably from polysiloxanes, alone or as mixtures with one or more of the polymers listed hereinabove.

The elastomer matrix of the composite material of the present invention, whether it comprises one or more of the elastomers listed above, may be subjected a posteriori, that is to say after incorporation of the zeolite, to a physicochemical treatment such as crosslinking or curing, or any other desired treatment for the intended use.

The preparation of the composite material of the present invention may be carried out by simple mixing of the zeolite and the elastomer matrix according to techniques well known to those skilled in the art for incorporating mineral fillers into polymeric materials. Accordingly, mixing may be carried out for example, and without limitation, in an extruder, in a laminar mixer or a calender, in a twin-screw mixer, in a Brabender-type mixer with rotating blades, of various forms suitable for each type of matrix, or in Banbury-type devices in which two spiral rotors turn in opposite directions at a variable speed of rotation.

As indicated previously, it is possible at this stage to add one or more additives. The incorporation temperature is adjusted as a function of the type of elastomeric polymer and may very generally be between 20° C. and 400° C.

The composite material of the invention can be shaped into the desired form for the end use, for example by moulding, extrusion, extrusion-moulding, rolling, etc.

The intrinsic properties of the 3A zeolite described previously greatly facilitate its incorporation into the elastomer matrix. The improved rheological behaviour brought about by the lower viscosity has resulted in the observation of a substantial reduction in the viscosity of the mixture and/or a possibility of incorporating a larger amount of zeolite into the elastomer matrix, and accordingly an operation for the incorporation of zeolite that is substantially less energy intensive and/or more rapid. This permits a reduction in the preparation time of the composite material according to the invention, making its industrial production much more profitable (improved productivity) and/or consequently affording the possibility of increasing the proportion of zeolite in said composite material and thus boosting the adsorption properties for the same mass of said composite material.

The composite material of the present invention finds very advantageous use as an adsorbent composite material and especially as a desiccant composite material that can be used in particular for the production of master batches, for packaging, for the production of double-glazing, for use in the pharmaceutical, paramedical, food-processing, electronic, automotive and construction sectors, to name but a few possible uses.

The examples that follow serve to illustrate the object of invention and are provided as a guide only, without any intention to in any way limit the various embodiments of the present invention.

In the examples that follow, the physical properties of the zeolites are evaluated by methods known to those skilled in the art, the main ones of which are reiterated below.

### Characterization Techniques

The physical properties of the zeolites are evaluated by methods known to those skilled in the art, the main ones of which are reiterated below.

### Zeolite Crystal Particle Size:

The number-average diameter of the zeolite crystals is estimated by observation in a scanning electron microscope (SEM). In order to estimate the size of the zeolite crystals in the samples, a set of images is taken at a magnification of at least 5000. The diameter of at least 200 crystals is then measured using dedicated software, for example the Smile View software published by LoGraMi. The accuracy is of the order of 3%.

### Chemical Analysis of the Zeolites, Determination of the Si/Al Molar Ratio and Degree of Exchange:

Elemental chemical analysis of the zeolite powder according to the invention may be carried out according to various analytical techniques known to those skilled in the art. These techniques include the technique of chemical analysis by X-ray fluorescence as described in the standard NF EN ISO 12677:2011 in a wavelength-dispersive spectrometer (WDXRF), for example a Tiger S8 instrument from Bruker.

X-ray fluorescence is a non-destructive spectral technique that exploits the photoluminescence of atoms in the X-ray range so as to establish the elemental composition of a sample. Excitation of the atoms, generally with an X-ray beam or by electron bombardment, generates specific radiations after return to the ground state of the atom. After calibrating for each oxide, a measurement uncertainty of less than 0.4% by weight is conventionally obtained.

Examples of other methods of analysis include atomic absorption spectrometry (AAS) and inductively-coupled plasma atomic emission spectrometry (ICP-AES), as described in standards NF EN ISO 21587-3 or NF EN ISO 21079-3, on an instrument such as the Perkin Elmer 4300DV.

The X-ray fluorescence spectrum has the advantage of depending very little on the chemical combination of the element and offers accurate determination, both quantitatively and qualitatively. After calibrating for each oxide SiO₂ and Al₂O₃, and also for different oxides (such as those originating from exchangeable cations, for example potassium), a measurement uncertainty of less than 0.4% by weight is conventionally obtained. The elemental chemical analyses described above thus make it possible to verify both the Si/Al molar ratio of the zeolite used and the degree of exchange of monovalent and bivalent cations.

In the description of the present invention, the measurement uncertainty of the Si/Al molar ratio is ±5%. The measurement of the Si/Al molar ratio of the zeolite present in the composite material can also be determined by solid-state silicon nuclear magnetic resonance (NMR) spectroscopy.

The degree of exchange by a given cation is calculated by evaluating the ratio between the number of moles of said cation (expressed in mole equivalents, that is to say in number of moles of electric charges, or 2 times the number of moles of the cation when the cation is divalent) and the number of moles of exchangeable sites, which is equal to the number of moles of aluminium present in the zeolite framework.

The respective amounts of each cation are evaluated by chemical analysis of the corresponding cations, the amount of each of the cations being evaluated by chemical analysis of the corresponding oxides (Na₂O, CaO, K₂O, MgO, etc.). The amount of hydronium ion is on the other hand calculated by subtracting the number of moles of aluminium present in the zeolite framework from the total number of moles of other cations present in the zeolite (expressed in mole equivalents).

### X-Ray Diffraction

The identification of the zeolites present in the composite material of the invention is evaluated by X-ray diffraction analysis, known to those skilled in the art under the acronym XRD, after treatment with solvent to dissolve the elastomer matrix, the choice of solvent being made according to the nature of the elastomer. The solid sample collected after dissolution and removal of solvent is analysed on an XRD diffractometer from Bruker.

This analysis makes it possible to identify the various zeolites present in the sample, since each of the zeolites has a unique diffractogram defined by the positions of the diffraction peaks and by their relative intensities.

The sample collected is ground and then spread out and levelled on a sample holder by simple mechanical compression. The conditions under which the diffractogram is acquired on the Bruker D8 Advance diffractometer are as follows:
Cu tube used at 40 kV-30 mA;
Soller slit size=2.5°, with an irradiation surface width of 16 mm;
sample device rotating at: 10 rpm;
measurement range: 4°<2θ<70°;
increment: 0.015°;
counting time per increment: 0.8 seconds.

The diffractogram obtained is interpreted using the EVA software with identification of the zeolites with the aid of the ICDD PDF-2 database, 2011 release. The amount by weight of the zeolite fractions is measured by XRD and evaluated by means of the TOPAS software from Bruker.

### Test of Adsorption of Small Molecules

The purpose of the test of adsorption of small molecules, for example oxygen, is to verify that the 3A zeolite that is useful in the context of the present invention has very little or no adsorption capacity for said small molecules.

The test is carried out using a commercial gas adsorption apparatus (Tristar 2 from Micromeritics) according to a volumetric method. About 10 g of sample is placed in a glass cell and degassed under reduced pressure at room temperature for at least 15 hours. After degassing, the sample is placed under helium and weighed to determine the mass of the anhydrous sample. The sample is then brought into contact with a known volume of oxygen at 600 mmHg. It is maintained in the presence of oxygen for 24 h at 25° C. The oxygen end pressure in the cell is then measured, which allows the amount of oxygen adsorbed by the sample to be calculated by difference. Adsorption is considered to be low if it is less than 25 Ncm³g⁻¹, preferably less than 20 Ncm³g⁻¹, more preferably less than 15 Ncm³g⁻¹, and advantageously less than 12 Ncm³g⁻¹.

### EXAMPLES

Various zeolite/elastomer mixtures are prepared according to the following procedure: a peroxide-type crosslinking agent (Luperox P from Arkema, 3.8 g or 1.9 phr (parts per hundred of rubber)) is first added, while stirring, to 200 g (100 phr) of zeolite. This premix (PM) is then introduced into 200 g (100 phr) of a silicone polymer matrix (Silicone R401_70S from Wacker Chemie AG) using a Lescuyer double-roll mixer.

The mixer is operated for about 60 minutes at a temperature of 20° C. After 25 to 30 minutes of operation, the unincorporated mass of premix (that is to say rejected at the foot of the double roll), termed the “reject mass”, is weighed and then reintroduced into the mixture for between 30 minutes and 60 minutes. The results are considered acceptable when the reject mass is less than 20 grams. The speeds of rotation of the rolls (diameter 150 mm) are different: 18 revolutions per minute for the rear roll and 24 revolutions per minute for the front roll. The gap between the two rolls is about 3 mm. A homogeneous mixture is obtained in the form of a sheet having a length of about 60 cm and a width of about 15 cm and a thickness of 3 mm.

Measurements of the rheological behaviour are likewise carried out on the resulting sheets using an oscillating-matrix plate/plate rheometer (France Scientifique model MDR-C) at 130° C. for 60 minutes, during which time the silicone matrix undergoes crosslinking. The rheometer is operated according to the ISO 6502 and ASTM D5289 standards.

The sheets of the composite materials prepared with 3A zeolite crystals partially exchanged with calcium as the bivalent cation have a minimum torque lower than that obtained with 3A zeolite crystals without bivalent cation, which demonstrates that a smaller amount of energy is needed to mix the inventive 3A zeolite crystals containing bivalent cations with the polymer matrix. This is because a mixture having greater fluidity (reduced viscosity) is obtained with the inventive zeolite 3A crystals, all the more so when the degree of bivalent cation exchange is high, as was observed with calcium.

The characteristics of the sheets of the composite materials tested are collated in Table 1 below (in which DE is the degree of cation exchange):

TABLE 1

| | | | | | DE | Crystal | Reject | Minimum | Adsorption |
|---|---|---|---|---|---|---|---|---|---|
| | DE Na | DE K | DE Ca | DE Mg | hydronium | size | mass | torque | of O₂ |
| Zeolite | (%) | (%) | (%) | (%) | (%) | (μm) | (g) | (dNm) | (Ncm³ g⁻¹) |
| 1 (comp.) | 60 | 40 | 0 | 0 | 0 | 2.5 | 25 | 11.3 | 55 |
| 2 | 44.5 | 45 | 9.5 | 0 | 1 | 2.5 | 10 | 7.2 | 6 |
| 3 | 33 | 47 | 19 | 0 | 1 | 2.5 | 8 | 6.5 | 10 |
| 4 (comp.) | 46 | 30 | 23 | 0 | 1 | 2.5 | 6 | 5.7 | 93 |
| 5 | 45 | 46 | 0 | 7 | 2 | 2.5 | 17 | 6.6 | 8 |

1. A composite material comprising:
a) at least one elastomer, and
b) an amount equal to or greater than 30% by weight, relative to the total weight of the composite material, of type 3A zeolite in which the cationic sites are occupied by the potassium cation, the sodium cation, at least one alkaline earth metal cation from column IIA of the periodic table and the hydronium ion.

2. The composite material according to claim 1, wherein the cationic sites are occupied to an extent of from 35% to 70% inclusive by the potassium cation, to an extent of from 2% to 62% inclusive by the sodium cation, to an extent of from 2% to 30% inclusive by at least one alkaline earth metal cation selected from magnesium, calcium, strontium and barium, and to an extent of from 1% to 5% inclusive by the hydronium cation, percentages being expressed in moles of cation relative to the total number of moles of exchangeable sites.

3. The composite material according to claim 1, wherein the alkaline earth metal cation is selected from the magnesium cation and the calcium cation and also mixtures thereof in any proportions.

4. The composite material according to claim 1, wherein the selected alkaline earth metal cation is calcium, the cationic sites are occupied by the calcium cation within a range of between 5% and 30% inclusive.

5. The composite material according to claim 1, wherein the 3A zeolite crystals have a number-average diameter, calculated by counting in SEM images, of between 0.1 μm and 4.0 μm inclusive.

6. The composite material according to claim 1, wherein the zeolite content is between 30% and 90% inclusive, relative to the total weight of the composite material.

7. The composite material according to claim 1, additionally comprising an amount less than or equal to 20%, relative to the total weight of the zeolite(s), of one or more other zeolites selected from zeolites of the LTA type, such as 4A zeolites and 5A zeolites, from faujasites (FAU of the LSX, MSX, X or Y type) having a Si/Al molar ratio of between 1 and 100, from type EMT zeolites, from type MFI zeolites having a Si/Al molar ratio of between 5 and 500, from type GIS zeolites (for example zeolite P), from type SOD zeolites (such as sodalite), from type MOR zeolites, from type HEU zeolites and from type BEA zeolites.

8. The composite material according to claim 1, additionally comprising one or more additives selected from crosslinkers, colorants, pigments, antibacterial agents, antifog agents, swelling agents, dispersants, lubricants, flame retardants, fillers, binding agents and compatibilizers of the functional polyolefin type.

9. The composite material according to claim 1, wherein the elastomer matrix comprises one or more elastomers selected from polysiloxanes, natural rubber, polybutadienes, polynitriles, hydrogenated or partially hydrogenated polynitriles, styrene-isoprene-butadiene rubber, polyisobutylenes and polyisobutenes, halogenated or non-halogenated isobutylene-isoprene elastomer copolymers, polychloroprenes, EPDM rubbers, chlorinated polyethylenes, polysulfonated rubbers, polyisoprenes and also mixtures of two or more thereof, in any proportions.

10. Use of a composite material according to claim 1 as an adsorbent composite material, as a desiccant composite material, for the production of master batches, for packaging and for the production of double-glazing.
